(19) United States
(12) Patent Application Publication
(10) Pub. No.: US 2013/0108322 A1
(43) Pub. Date: May 2, 2013

(54) Process Unit and Image Forming Device Including the Same

(71) Applicant: Takahiro Nishimoto, Ogaki-shi (JP)

(72) Inventor: Takahiro Nishimoto, Ogaki-shi (JP)

(21) Appl. No.: 13/625,181

(22) Filed: Sep. 24, 2012

(30) Foreign Application Priority Data
Oct. 31, 2011 (JP) 2011-239349

(51) Int. Cl. G03G 21/00

(52) U.S. Cl. 399/127

(57) ABSTRACT

A process unit is capable of avoiding backset of residual toner from the collecting unit to an image carrier even after collection of the residual toner on the image carrier at the collecting unit. A first collecting member is positioned downstream of a transfer unit and upstream of a charger in rotational direction of an image carrier. The first collecting member is configured to allow a developing agent remaining on the image carrier to pass therethrough but to collect a paper dust on the image carrier. A second collecting member is positioned downstream of the first collecting member and upstream of the charger, and configured to allow a developing agent remaining on the image carrier to pass therethrough but to collect a paper dust on the image carrier. The control device controls the first collecting member to be applied with a polarity the same as that of the charger.

### CROSS REFERENCE TO RELATED APPLICATION

This application claims priority from Japanese Patent Application No. 2011-239349 filed Oct. 31, 2011. The entire content of the priority application is incorporated herein by reference.

### TECHNICAL FIELD

The present invention relates to a process unit including an image carrier and a developing unit, and to an image forming device provided with the process unit.

### BACKGROUND

Conventional image forming device is provided with a process unit including a photosensitive drum as an image carrier on which an electrostatic latent image is carried, a developing cartridge as an developing unit adapted to supply developing agent to the electrostatic latent image, and a transfer roller nipping a sheet in cooperation with the photosensitive drum for transferring developing agent image on the photosensitive drum to the sheet. According to the conventional process unit, a cleaner-less system is employed in which residual developing agent, hereinafter simply referred to as “residual toner” remaining on the photosensitive drum is collected at the developing cartridge and is reused for the subsequent image forming operation.

Paper dust may be adhered onto the photosensitive drum that nips the sheet in cooperation with the transfer roller. If the paper dust is also collected along with the developing agent into the developing cartridge, degradation of the developing agent occurs. To avoid this problem, the conventional process unit is provided with a first paper dust removing unit for removing a fibrous dust and a second paper dust removing unit for removing a powdered paper dust.

More specifically, the first paper dust removing unit includes a brush member and is positioned downstream of the transfer roller in the rotational direction of the photosensitive drum, and the second paper dust removing unit includes a non-woven fabric sheet, and is positioned downstream of the first paper dust removing unit in the rotational direction. With this structure, fibrous paper dust having a mass larger than that of the powered paper dust can be collected at the first paper dust removing unit, and the powered paper dust of small mass that has not been collected at the first paper dust removing unit can be collected at the second paper dust removing unit.

### SUMMARY

However, the present inventor has found that even though the above-described structure can collect paper dust on the photosensitive drum, the first paper dust removing unit may function as a dam damming the residual toners, and the dammed residual toner may be moved onto an electrostatic latent image on the photosensitive drum. Such slip back of the residual toner may degrade imaging.

Thus, it is an object of the present invention to provide a process unit and an image forming device provided with the same capable of reducing go back of the residual toner onto the image carrier even after the collection of the residual toner on the image carrier at a paper dust removing unit adapted to collect paper dust on the image carrier.

In order to attain above and other objects, the present invention provides a process unit. The process unit includes an image carrier, a developing member, a transfer unit, a charger, a cleaning unit, and a control device. The image carrier is rotatable in a rotational direction. The developing member is configured to supply a developing agent applied with a polarity to the image carrier. The transfer unit is configured to transfer developing agent on the image carrier to an image recording medium. The developing member is also configured to collect a developing agent not transferred onto the image recording medium but remaining on the image carrier. The charger is positioned downstream of the transfer unit and upstream of the developing member in the rotational direction. The charger is configured to be applied with a polarity the same as the polarity of the developing agent. The cleaning unit includes a first collecting member and a second collecting member. The first collecting member is positioned downstream of the transfer unit and upstream of the charger in the rotational direction. The first collecting member is configured to allow a developing agent remaining on the image carrier to pass through the first collecting member but to collect a paper dust on the image carrier. The second collecting member is positioned downstream of the first collecting member and upstream of the charger in the rotational direction, and configured to allow a developing agent remaining on the image carrier to pass through the second collecting member but to collect a paper dust on the image carrier without application of bias to the second collecting member. The control device is configured to control the first collecting member to be applied with a polarity the same as the polarity of the charger when an image forming operation is performed.

According to another aspect, the present invention provides an image forming device having a process unit as described above.

According to still another aspect, the present invention provides a process unit. The process unit includes an image carrier, an exposure unit, a developing member, a supply member, a transfer unit, a cleaning unit, and a control device. The image carrier is rotatable in a rotational direction. The exposure unit is configured to scan over the surface at an exposure position to form the electrostatic latent image. The developing member is configured to supply a developing agent to the electrostatic latent image. The supply member is configured to supply the developing agent to the developing member. The developing agent is subjected to triboelectric charging with a polarity between the supply member and the developing member. The transfer unit is configured to transfer a developing agent on the image carrier to an image recording medium. The developing member is also configured to collect a developing agent not transferred onto the image recording medium but remaining on the image carrier. The cleaning unit includes a first collecting member and a second collecting member. The first collecting member is positioned downstream of the transfer unit and upstream of the exposure position in the rotational direction. The first collecting member is configured to allow a developing agent remaining on the image carrier to pass through the first collecting member but to collect a paper dust on the image carrier. The second collecting member is positioned downstream of the first collecting member and upstream of the exposure position, and configured to allow a developing agent remaining on the image carrier to pass through the second collecting member but to physically collect a paper dust on the image carrier without application of bias to the second collecting member. The control device is configured to control the first collecting member to be applied with a polarity the same as the polarity of the developing agent when an image forming operation is performed.

### BRIEF DESCRIPTION OF THE DRAWINGS

In the drawings;

FIG. 1 is a cross-sectional side view of a laser printer provided with a process unit according to an embodiment of the present invention;

FIG. 2(a) is a schematic view of a photosensitive drum and its ambient components in the process unit according to the embodiment;

FIG. 2(b) is an enlarged view of a flocking portion of a second collecting portion in the process unit according to the embodiment;

FIG. 3(a) is a schematic view showing a state where an electrostatic latent image is formed on a surface of a photosensitive drum in the process unit according to the embodiment;

FIG. 3(b) is a schematic view showing a state where toner is supplied to the electrostatic latent image in the process unit according to the embodiment;

FIG. 4(a) is a view showing a state where toner on the photosensitive drum is transferred onto a sheet in the process unit according to the embodiment;

FIG. 4(b) is a view showing a state where a primary cleaning roller collects powdered paper dust in the process unit according to the embodiment;

FIG. 5(a) is a view showing a state where a pressing unit collects fibrous paper dust on the photosensitive drum in the process unit according to the embodiment; and

FIG. 5(b) is a view showing a state where a developing roller collects toner on the photosensitive drum in the process unit according to the embodiment.

### DETAILED DESCRIPTION

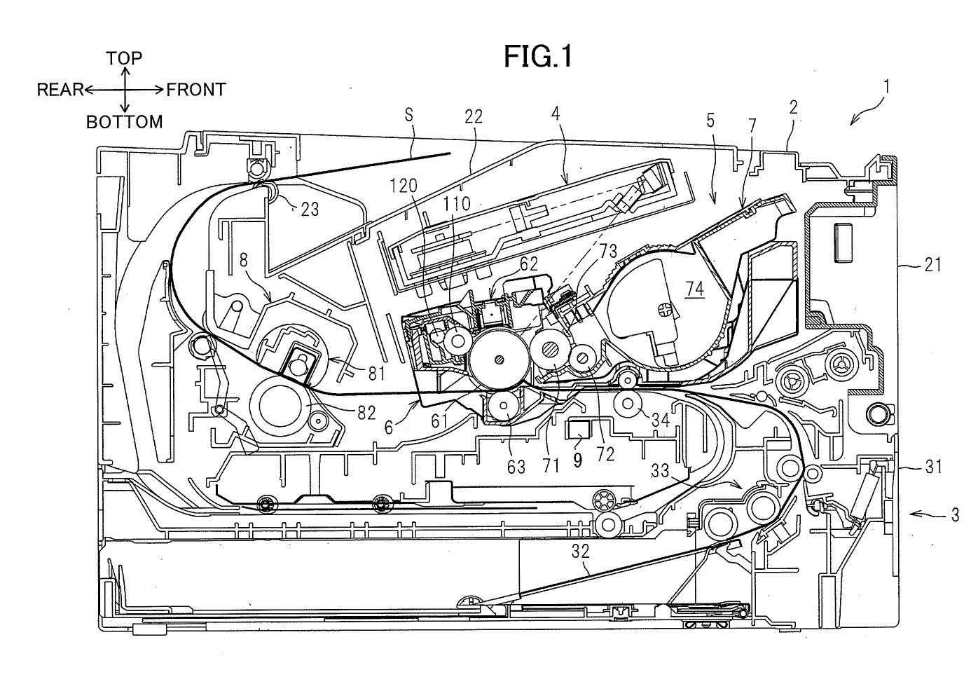

A color laser printer 1 as an image forming device provided with a process cartridge according to an embodiment of the present invention will be described with reference to FIG. 1. Throughout the specification, the terms “upward”, “downward”, “upper”, “lower”, “above”, “below”, “beneath”, “right”, “left”, “front”, “rear” and the like will be used assuming that the image forming device is disposed in an orientation in which it is intended to be used. More specifically, in FIG. 1 a right side and a left side are a front side and a rear side, respectively.

[Overall Structure of the Laser Printer]

As shown in FIG. 1, the laser printer 1 includes a main frame 2, a sheet supply unit 3 for supplying a sheet S, an exposure unit 4, a process unit 5 for transferring a toner image onto the sheet S, and a fixing unit 8 for thermally fixing toner image to the sheet S.

The sheet supply unit 3 is provided at a lower internal portion of the main frame 2, and includes a sheet supply tray 31, a pressure plate 32, and a sheet supply mechanism 33. The sheets S accommodated in the sheet supply tray 31 are urged upward by the pressure plate 32, and each sheet is supplied to the process unit 5 (to a portion between a photosensitive drum 61 and a transfer roller 63) by the sheet supply mechanism 33.

The exposure unit 4 is positioned at an upper internal portion of the main frame 2, and includes a laser emitting portion (not shown), a polygon mirror, lens and a reflection mirror. In the exposure unit 4, a laser beam is emitted from the laser emitting portion based on image data, and is scanned at high speed over an outer peripheral surface of the photosensitive drum 61 as shown by a two dotted chain line, whereupon the surface of the photosensitive drum 61 is exposed to laser beam.

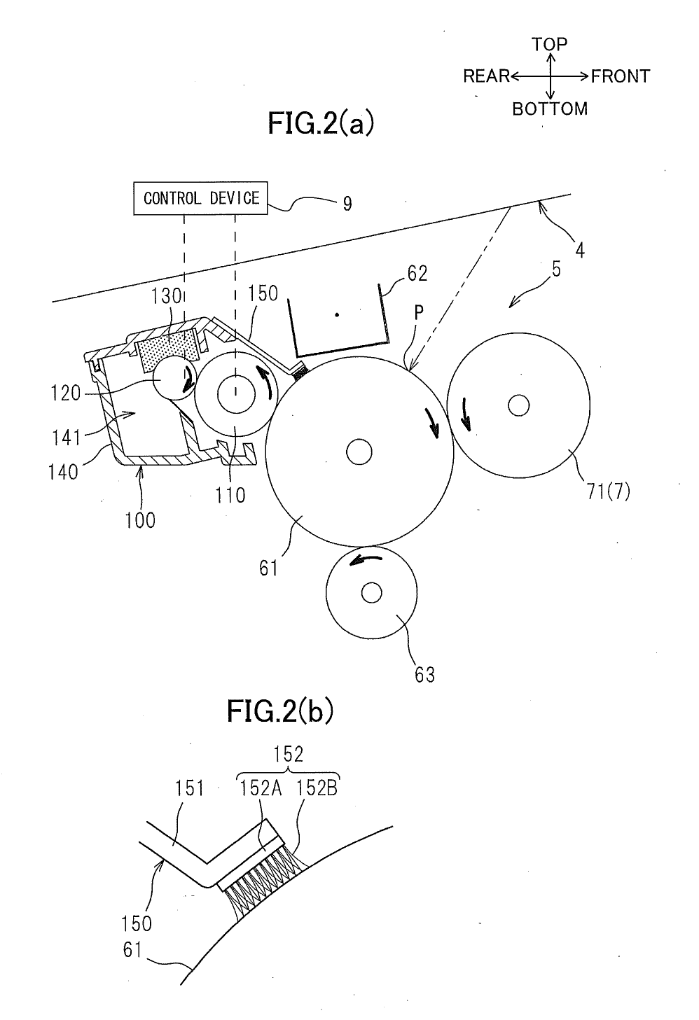

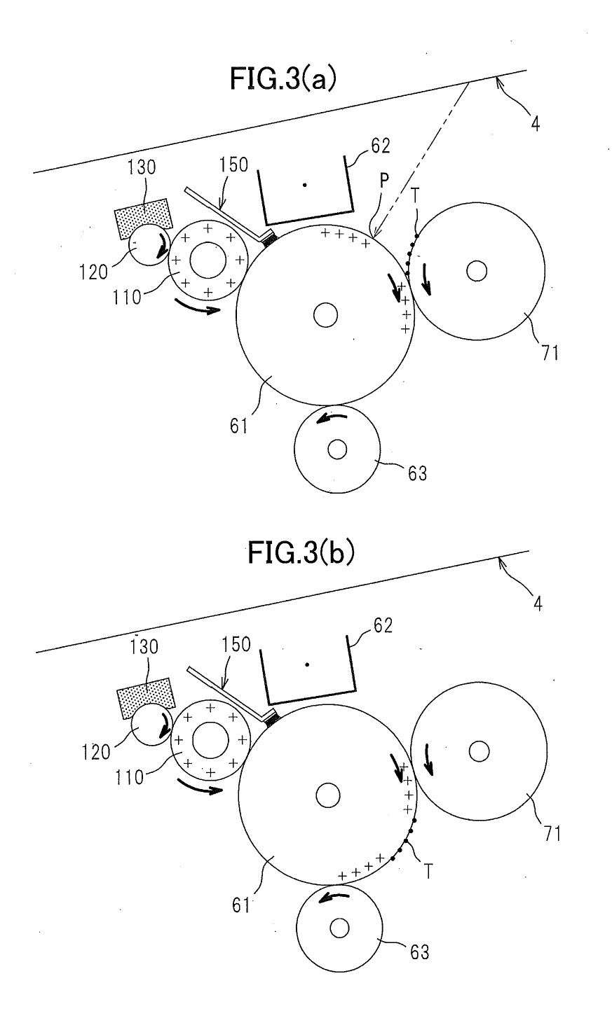

The process unit 5 is positioned below the exposure unit 4, and is configured to be attached to or detached from the main frame 2 through an opening, which is opened by opening a front cover 21. The process unit 5 includes a drum cartridge 6 and a developing cartridge 7. The process unit 5 is electrically connected to a control device 9 provided in the main frame 2 for controlling the process unit 5 when an image forming operation is performed (FIGS. 1 and 2). In the FIGS. 3-5, depiction of the control device 9 is omitted.

The drum cartridge 6 includes the photosensitive drum 61, a charger 62, and the transfer roller 63. The developing cartridge 7 is configured to be attached to or detached from the drum cartridge 6. The developing cartridge 7 includes a developing roller 71, a supply roller 72, a thickness regulation blade 73, and a toner chamber 74.

In the process unit 5, after the outer peripheral surface of the photosensitive drum 61 is uniformly charged with a positive polarity by the charger 62, the surface is exposed to laser beam with high speed scanning by the exposure unit 4. Thus, potential of the exposed portion is lowered to form an electrostatic latent image based on the image data on the surface of the photosensitive drum 61. Further, toner in the toner chamber 74 is supplied to the developing roller 71 through the supply roller 72. In this instance, the toner is subjected to triboelectric charging with positive polarity between the supply roller 72 and the developing roller 71. The toner on the developing roller 71 is moved to the thickness regulation blade 73 in accordance with the rotation of the developing roller 71, and is carried on the developing roller 71 in a form of a thin toner layer having a uniform thickness while the toner being further triboelectrically charged.

The toner carried on the developing roller 71 is supplied onto the photosensitive drum 61 where the electrostatic latent image is formed. Thus, the electrostatic latent image becomes a visible toner image. Then, the toner image is transferred onto the sheet S when the sheet S is moved past the photosensitive drum 61 and the transfer roller 63.

The fixing unit 8 is positioned behind the process unit 5, and includes a heater unit 81 including a halogen heater, a fixing belt, and a nip plate, and a pressure roller 82 configured to nip the fixing belt in cooperation with the nip plate. In the fixing unit 8, the toner image carried on the sheet S is thermally fixed to the sheet S when the sheet S is moved past the heater unit 81 and the pressure roller 82. A sheet discharge roller 23 and a discharge tray 22 are provided. The sheet S on which the toner image has been thermally fixed is discharged onto the discharge tray 22 by the sheet discharge roller 23.

The laser printer 1 employs a cleaner-less system in which residual toner not transferred to the sheet S but remaining on the photosensitive drum 61 is collected by the developing cartridge 7 and is re-used for a subsequent image forming operation. More specifically, for collecting residual toner, the surface of the photosensitive drum 61 is charged to permit the surface potential of the photosensitive drum 61 to be higher than the potential of the developing roller 71. As a result, residual toner having positive polarity on the photosensitive drum 61 is moved to the developing roller 71, and is returned to the toner chamber 74.

[Details of Process Unit]

As shown in FIG. 2, the process unit 5 includes the photosensitive drum 61, the charger 62, the transfer roller 63, the developing roller 71 and a cleaning unit 100. As described above, the developing roller 71 is adapted to supply toner T to the electrostatic latent image on the photosensitive drum 61. The developing roller 71 is rotatable and is in contact with the peripheral surface of the photosensitive drum 61. The contacting position is downstream, in the rotational direction of the photosensitive drum 61, of an exposure position P at which the laser beam emitted from the exposure unit 4 is irradiated. The transfer roller 63 is positioned downstream of the developing roller 71 in the rotational direction of the photosensitive drum 61.

The charger 62 is applied with a charging bias so as to charge the surface of the photosensitive drum 61 with the positive polarity. The charger 62 is positioned downstream of the transfer roller 63 and upstream of the developing roller 71 in the rotational direction of the photosensitive drum 61.

The cleaning unit 100 is positioned downstream of the transfer roller 63 and upstream of the charger 62 in the rotational direction of the photosensitive drum 61. Further, the cleaning unit 100 is positioned downstream of the transfer roller 63 and upstream of the exposure position P in the rotational direction. The cleaning unit 100 includes a primary cleaning roller 110, a secondary cleaning roller 120, a scraper 130, a casing 140, and a pressing unit 150. Each of the primary and secondary cleaning rollers 110, 120 is electrically connected to the control device 9 for controlling an application of bias thereto.

The primary cleaning roller 110 includes a roller body and an outer sponge formed over a surface of the roller body, and is in contact with the outer peripheral surface of the photosensitive drum 61 while being rotated about its axis. The primary cleaning roller 110 is configured to allow toner on the photosensitive drum 61 to pass therethrough, while temporarily collect powdered paper dust on the photosensitive drum 61. More specifically, the control device 9 controls the primary cleaning roller 110 to be applied with a bias voltage with a positive polarity, and has a surface potential greater than that of the light-exposed portion of the photosensitive drum 61. With this structure, powdered paper dust charged with negative polarity on the photosensitive drum 61 is attracted into the primary cleaning roller 110 and is collected into a recessed or pored portion of the sponge.

The secondary cleaning roller 120 is in contact with the primary cleaning roller 110 and is rotatable about its axis, and is configured to adsorb powdered paper dust retained on the primary cleaning roller 110.

More specifically, the secondary cleaning roller 120 is positioned diagonally above and rearward of the primary cleaning roller 110 and in confrontation therewith. The control device 9 controls the secondary cleaning roller 120 to be applied with positive voltage whose absolute value is greater than that applied to the primary cleaning roller 110. Thus, the secondary cleaning roller 120 attracts and holds therein powdered paper dust retained on the primary cleaning roller 110.

The scraper 130 is adapted to scrape off the paper dust deposited on the secondary cleaning roller 120. The scraper 130 is positioned above the secondary cleaning roller 120 such that the secondary cleaning roller 120 is in rotational sliding and pressure contact with the scraper 130. The scraper 130 is formed of a sponge.

The casing 140 accommodates therein the primary and secondary cleaning rollers 110 and 120, and defines therein an accumulating portion 141 at a position below the secondary cleaning roller 120 for accumulating powdered paper dust.

The pressing unit 150 is supported to the casing 140 and includes a support member 151 and a flocking portion 152. The pressing unit 150 is configured to collect fibrous paper dust on the photosensitive drum 61 by pressing the flocking portion 152 onto the photosensitive drum 61 while toner on the photosensitive drum 61 is passing through the flocking portion 152.

The support member 151 is resiliently flexible and extends toward the photosensitive drum 61 from the casing 140. The support member 151 has a base end portion fixed to the casing 140 and a free end portion provided with the flocking portion 152. A frame of the drum cartridge 6 is provided with a rib (not shown) for urging a free end portion of the support member 150 toward the casing 140 in order to permit the flocking portion 152 to be stably in contact with the outer peripheral surface of the photosensitive drum 61.

As shown in FIG. 2(b), the flocking portion 152 includes a base fabric 152A fixed to the free end portion of the support member 151, and a fiber implantation 152B formed on the base fabric 152A. The fiber implantation 152B is in the form of a fiber bundle, and each fiber may be coat, hair, pelage, trichome, fluffing, etc, having a diameter ranging from 5 to 10 μm and length ranging from 0.5 to 0.7 mm implanted in the base fabric 152A. Preferably, density of the fiber implantation is 1,500 to 15,000 numbers of fibers per 1 mm².

The flocking portion 152 is fixed to the free end portion of the support member 151, and is positioned downstream of the primary cleaning roller 110 and upstream of the charger 62 in the rotational direction of the photosensitive drum 61 such that the fibers are in contact with the outer peripheral surface of the photosensitive drum 61. Further, the flocking portion 152 is positioned downstream of the primary cleaning roller 110 and upstream of the exposure position P in the rotational direction.

In operation, for image forming operation, the surface of the photosensitive drum 61 is charged with positive polarity by the charger 62, and then is exposed to laser beam emitted from the exposure unit 4 at the exposure position P by way of high speed scanning. Thus, potential of the light exposed portion becomes lowered as shown in FIG. 3(a). When the light exposed portion reaches the developing roller 71, toner T charged with positive polarity and held on the developing roller 71 is transferred to the light-exposed portion of the photosensitive drum 61 as shown in FIG. 3(b).

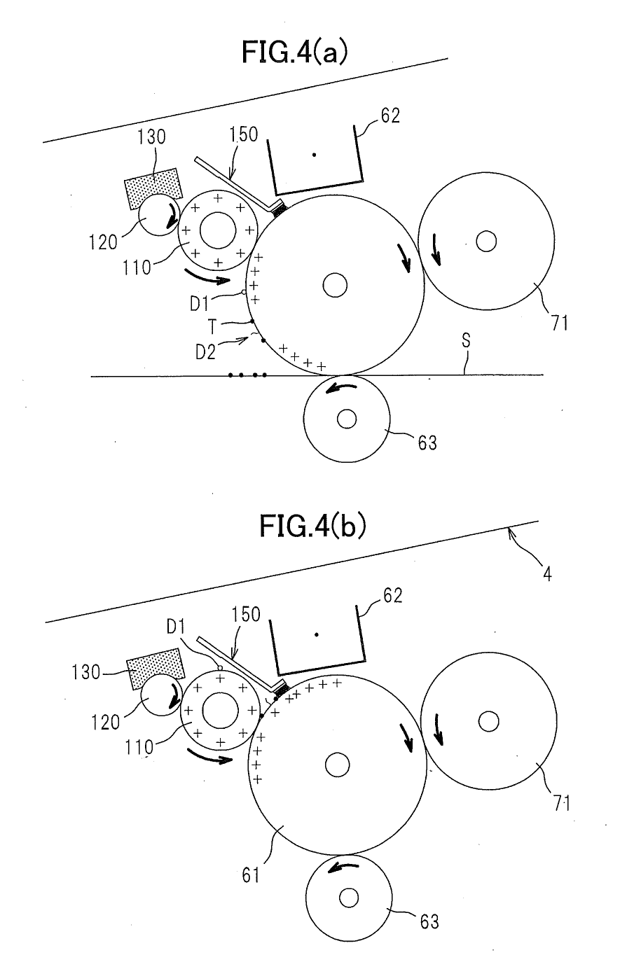

Upon further rotation of the photosensitive drum 61, toner T on the photosensitive drum 61 is transferred onto the sheet S passing through a gap between the photosensitive drum 61 and the transfer roller 63 as shown in FIG. 4(a). In this case, powdered paper dust D1 and fibrous paper dust D2 having a mass greater than that of the powdered paper dust D1 those being changed with negative polarity are transferred from the sheet S to the photosensitive drum 61. Further, residual toner T those not being transferred onto the sheet S remain on the photosensitive drum 61.

Then, the powered paper dust D1 and the fibrous paper dust D2 on the photosensitive drum 61 are collected at the primary cleaning roller 110 and pressing unit 150, respectively.

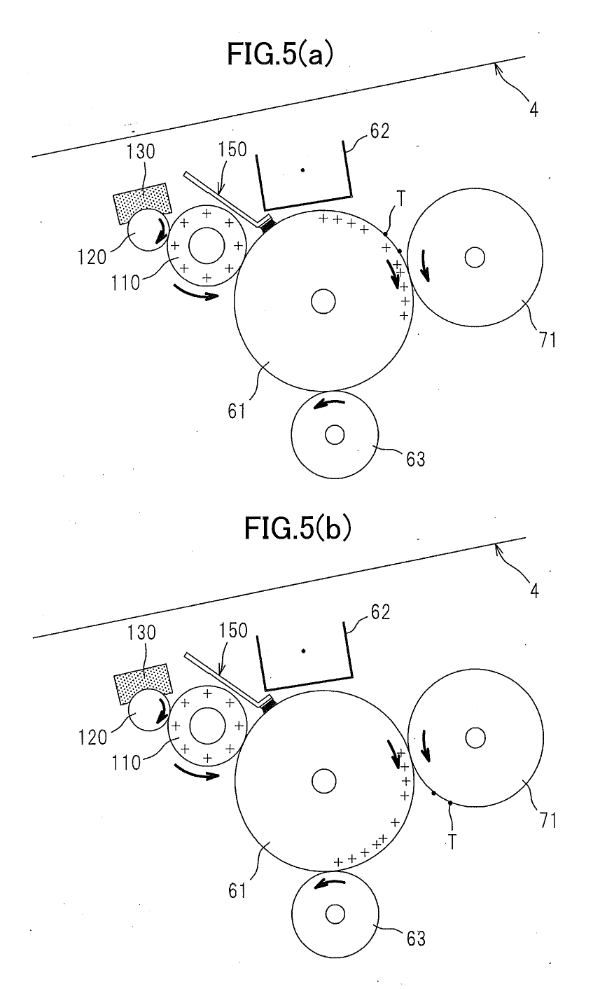

More specifically, the powdered paper dust D1 is attracted to the primary cleaning roller 110 by coulomb force as shown in FIG. 4(b), and is collected at the recessed or pored portion of the sponge of the primary cleaning roller 110. On the other hand, the fibrous paper dust D2 is not collected at the sponge, but passes through the primary cleaning roller 110. However, the fibrous paper dust D2 is trapped by the fibers at the flocking portion 152 as shown in FIG. 5(a).

In this way, the powdered paper dust D1 having a minute diameter can be collected at the primary cleaning roller 110 by coulomb force, and fibrous paper dust D2 having a mass greater than the powdered paper dust D1 is collected at the pressing unit 150 as a result of trapping, i.e., the fibrous paper dust D2 is entangled with the fibers. Thus, paper dust on the photosensitive drum 61 can be effectively collected.

Further, powdered paper dust D1 can be collected by the primary cleaning roller 110, and the collected paper dust can be accumulated in the accumulating portion. Since the primary cleaning roller 110 is positioned upstream of the pressing unit 150 in the rotational direction of the photosensitive drum 61, an amount of paper dust collected at the pressing unit 150 can be reduced. Consequently, paper dust collection can be stably performed for a prolonged period of time.

Incidentally, almost all the residual toner on the photosensitive drum 61 is not collected at the primary cleaning roller 110 and the pressing unit 150, but are moved past the primary cleaning roller 110 and the pressing unit 150. However, there is a probability that the residual toner may be dammed at the pressing unit 150. In the latter case, the dammed residual toner may go back to the light-exposed portion of the photosensitive drum 61 whose potential is lowered to degrade imaging. However, according to the above-described embodiment, light-exposed portion of the photosensitive drum 61 can provide increased surface potential, since the primary cleaning roller 110 is in contact with the photosensitive drum 61 at a position upstream of the pressing unit 150 in the rotational direction of the photosensitive drum 61 and since the primary cleaning roller 110 is biased with positive polarity. Consequently, transfer of the residual toner T dammed at the pressing unit 150 onto the photosensitive drum 61 can be restrained or prevented. Accordingly, backset of the toner to the photosensitive drum 61 can be reduced to avoid degradation of imaging.

Further, since the control device 9 controls the primary cleaning roller 110 to be biased at the time of image forming operation, residual toner collected at the pressing unit 150 cannot be returned to the photosensitive drum 61 during the image forming operation. That is, backset of the residual toner during the image forming operation can be avoided.

Then, residual toner on the photosensitive drum 61 is collected at the developing roller 71 as shown in FIG. 5(b).

Various modifications are conceivable. For example, in the above-described embodiment the pressing unit 150 including the flocking portion 152 is employed as a second collecting portion. However, instead of the pressing unit 150, a brush whose tip end is in contact with the photosensitive drum 61 is available.

Further, in the above-described embodiment, the control device 9 controls the primary cleaning roller 110 to be biased only during the image forming operation. However, the primary cleaning roller can be biased upon turning ON the laser printer 1.

Further, in the above-described embodiment, the image recording medium is a sheet S such as a thick sheet, a post card, and a thin sheet. However, an intermediate image transfer belt is also available as the image recording medium.

Further, in the above-described embodiment, the photosensitive drum 61 is employed as the image carrier. However, a belt-like photosensitive member is also available as the image carrier.

Further, in the above-described embodiment, the laser printer 1 is exemplified as an image forming device provided with the process unit. However, a copying machine and a multi-function device are also available.

While the invention has been described in detail with reference to the embodiments thereof, it would be apparent to those skilled in the art that various changes and modifications may be made therein without departing from the spirit of the invention.

What is claimed is:

1. A process unit comprising:
an image carrier rotatable in a rotational direction;
a developing member configured to supply developing agent applied with a polarity to the image carrier;
a transfer unit configured to transfer developing agent on the image carrier to an image recording medium, the developing member being also configured to collect developing agent not transferred onto the image recording medium but remaining on the image carrier;
a charger positioned downstream of the transfer unit and upstream of the developing member in the rotational direction, the charger being configured to be applied with a polarity to charge the image carrier the same as the polarity of the developing agent;
a cleaning unit comprising:
a first collecting member positioned downstream of the transfer unit and upstream of the charger in the rotational direction, the first collecting member being configured to allow developing agent remaining on the image carrier to pass through the first collecting member but to collect a paper dust on the image carrier; and
a second collecting member positioned downstream of the first collecting member and upstream of the charger in the rotational direction, and configured to allow developing agent remaining on the image carrier to pass through the second collecting member but to collect a paper dust on the image carrier without application of bias to the second collecting member; and
a control device configured to control the first collecting member to be applied with a polarity the same as the polarity of the charger when an image forming operation is performed.

2. The process unit as claimed in claim 1, wherein the first collecting member comprises a primary cleaning roller configured to collect a powdered paper dust with coulomb force,
wherein the second collecting member comprises a flocking portion having a fiber bundle in contact with the surface of the image carrier.

3. The process unit as claimed in claim 2 wherein the cleaning unit further comprises:
a secondary cleaning roller configured to collect the paper dust from the primary cleaning roller;
a scraper configured to scrape off the paper dust from the secondary cleaning roller; and
a casing having an accumulating portion configured to accumulate therein the paper dust scraped by the scraper.

4. The process unit as claimed in claim 2, wherein the flocking portion further comprises a base fabric on which the fiber bundle is implanted, wherein the fiber bundle has fibers each having a diameter ranging from 5 to 10 μm.

5. The process unit as claimed in claim 4, wherein each fiber has a length ranging from 0.5 to 0.7 mm.

6. The process unit as claimed in claim 4, wherein the fiber bundle has a density of the fibers of from 1,500 to 15,000 numbers of fibers per 1 mm².

7. The process unit as claimed in claim 1, wherein the first collecting member is applied with a bias voltage at least at an image forming operation.

8. An image forming device having the process unit as claimed in claim 1.

9. A process unit comprising:
an image carrier rotatable in a rotational direction;
an exposure unit configured to scan over the surface at an exposure position to form an electrostatic latent image on the image carrier;
a developing member configured to supply developing agent to the image carrier;
a supply member configured to supply developing agent to the developing member, the developing agent being subjected to triboelectric charging with a polarity between the supply member and the developing member;
a transfer unit configured to transfer developing agent on the image carrier to an image recording medium, the developing member being also configured to collect developing agent not transferred onto the image recording medium but remaining on the image carrier;
a cleaning unit comprising:
a first collecting member positioned downstream of the transfer unit and upstream of the exposure position in the rotational direction, the first collecting member being configured to allow developing agent remaining on the image carrier to pass through the first collecting member but to collect a paper dust on the image carrier; and
a second collecting member positioned downstream of the first collecting member and upstream of the exposure position in the rotational direction, and configured to allow developing agent remaining on the image carrier to pass through the second collecting member but to collect a paper dust on the image carrier without application of bias to the second collecting member; and
a control device configured to control the first collecting member to be applied with a polarity the same as the polarity of the developing agent when an image forming operation is performed.
